(19) United States
(12) Patent Application Publication
(10) Pub. No.: US 2025/0045788 A1
(43) Pub. Date: Feb. 6, 2025

(54) System and Method for Generating a Rebate for an Electronic Commerce Transaction

(71) Applicant: Rebate Rumble Inc., Carson City, NV (US)

(72) Inventors: Hugo Enrique Pimienta, Tomball, TX (US); Fernando Pimienta, Tomball, TX (US)

(21) Appl. No.: 18/785,597

(22) Filed: Jul. 26, 2024

Related U.S. Application Data
(60) Provisional application No. 63/530,183, filed on Aug. 1, 2023.

(51) Int. Cl. G06Q 30/0207; G06Q 30/0601

(52) U.S. Cl. CPC G06Q 30/0212; G06Q 30/0641

(57) ABSTRACT

A system and method is provided for using a network-connected host device to facilitate a transaction, wherein the transaction involves the purchase of an item from a merchant, where the user can select a rebate for a least a portion of the purchase price of the item after the item has been purchased, where the host device uses at least a portion of the commission received as a result of the purchase to wager on an event, where the event is related to a prediction made by the user, and the outcome of the prediction (or event) determines whether the rebate is activated for processing, thereby resulting in at least a partial refund to the user. The rebate is preferably selected from a plurality of rebates having predictions, where each prediction is related to the user's stated or identified interests.

### BACKGROUND OF THE INVENTION

### 1. Field of the Invention

The present invention relates to a system and method for generating a rebate for an online purchase of an item by a user, where the rebate is based on an outcome of a prediction selected by the user. In one embodiment, a network-connected host device is used to facilitate the transaction, wherein the transaction involves the purchase of the item from the merchant, resulting in payment of a commission to the host. The host then uses the commission, or a portion thereof, to place a wager (e.g., on a sporting event) with an online casino, where the wager is selected based on at least one interest provided by the user. If the wager is won, a rebate is provided to the user for up to the purchase price of the item (e.g., depending on the commission, the prediction, etc.).

### 2. Description of Related Art

The Internet is used daily by hundreds of millions of people for a variety of reasons, including research, social networking, and shopping, to name a few. With respect to shopping, there are hundreds of thousands of websites (i.e., merchants) selling products over the Internet. While these websites differ in the types of products that they sell, and the prices at which the products are sold, the checkout (or backend payment) process is virtually identical. Once an item is selected, the item is placed in a virtual shopping cart, and paid for using a payment method provided by the user. Once the payment is successfully processed (e.g., using a payment gateway, payment processor, merchant account, etc.), the item is then provided (e.g., shipped) to the user.

The problem with this is that all ecommerce websites are competing for the same (or an overlapping group of) users. While most websites offer some feature to differentiate themselves, like free shipping, greater selection, lower prices, product reviews, etc., it is becoming harder and harder to stand out on the Internet and compete with giants like eBay,™ Amazon™, and Google™.

It would therefore be advantageous to operate a website that either competes with or supplements existing ecommerce websites by providing the user with a rebate that (a) is provided by the ecommerce website (not the manufacturer) and (b) is contingent on the occurrence of an event, where the user (or purchaser) is involved in the selection (or prediction) of the event. For example, the user may be an avid Las Vegas Raiders football fan and may express an interest in them winning the Superbowl. In exchange for using a particular ecommerce website to purchase an item from a merchant, the user would then be eligible for a rebate on the purchase price of the item (or a portion thereof), where the rebate is contingent on the user's prediction—in this case, the Las Vegas Raiders winning the Superbowl.

There are several advantages of the present invention. First, it provides the user with a rebate for purchasing an item in situations when one is not being offered by the manufacturer or the merchant from whom the item is being purchased. Instead, the rebate is provided by the ecommerce website used to facilitate the purchase (e.g., from which the user first visited). For example, as shown in FIG. 10, the ecommerce website may advertise a plurality of merchants from whom the user can purchase goods and/or services, where the purchase of said goods and/or services results in the ecommerce website receiving a commission (e.g., 25% of the purchase price). The ecommerce website can then invest the commission (or a portion thereof) on an event by way of an online bookmaker, where the event corresponds to a prediction made by the user. If the user's prediction is correct and the host's wager is won, a rebate in an amount up to the purchase price of the item is provided to the user.

Not only does this drive traffic to the merchant's website, but it provides the user with an opportunity to get at least a portion of the purchase price back by way of a rebate. It also does so in a way that shields both the user and the merchant from the actual wagering activity (e.g., for legal, social, or moral reasons). From the user's and the merchant's perspective, the system functions very similar to traditional online advertising where the user is redirected to the merchant's website in response to interacting with (e.g., clicking on) a link, where the advertising website is paid a commission on sales made as a result of the redirection. However, unlike traditional online advertising, the user also benefits by receiving a rebate whose activation is contingent on a prediction made by the user.

Not only is the present invention distinguishable from ecommerce and gambling websites that are currently available on the Internet, but it improves upon those websites by offering features that are currently not available. It also does so in a way that is convenient, trustworthy, and provides the user with a pleasurable experience. As discussed below, advancements in computer technology are required to implementing the present invention on the Internet-advancements that are non-conventional and address several drawbacks associated therewith (e.g., interfacing with existing ecommerce websites, shielding both the user and the merchant from all wagering activity, etc.).

### SUMMARY OF THE INVENTION

The present invention provides a system and method for using a network-connected host device to facilitate a transaction, wherein the transaction involves the purchase of an item from a merchant, where the user can select a rebate for a least a portion of the purchase price of the item after the item has been purchased, where the host device uses at least a portion of the commission received as a result of the purchase to wager on an event, where the event is related to a prediction made by the user, and the outcome of the prediction (or event) determines whether the rebate is activated for processing, thereby resulting in at least a partial refund to the user.

In a preferred embodiment of the present invention, a host device may communicate with a user device, a merchant device, and an online bookmaker via a wide area network (WAN), such as the Internet. In certain embodiments, the host may communicate with an affiliate network instead of or in addition to the merchant, where the affiliate network acts as a middleman between the host and the merchant.

The user starts by logging into the host's website, which may require the user to enter authenticating information, such as email address and password. If the user clicks on a link (or advertisement), then the user will be transported to the merchant's website or application (either directly or via an affiliate network), along with information (e.g., cookies, etc.) that identifies the host. This allows the merchant (or the affiliate network) to understand that the user came to their website or application via the host's website. This identifying information can either be sent to the merchant or affiliate network for linking the user's session on the merchant's website to the host.

Once the user is on the merchant's website, the user may then be able to search (or browse) the merchant's website and select an item for purchase and place the item in the user's virtual shopping cart on the merchant's website (i.e., a virtual shopping cart that is linked to the user's session with the merchant). The user may then provide the merchant with payment information to pay the purchase price. The item can then be shipped and commission(s) paid to the host.

At this time, the host may offer at least one rebate to the user for the item purchased from the merchant. In a preferred embodiment, the host offers a plurality of rebates to the user, where each rebate offers a different percentage of the paid purchase price (e.g., the price of the item prior to tax, shipping, etc.). For example, the user may be offered a 10% rebate, a 25% rebate, and a 50% rebate, with each rebate being tied (or linked) to individual predictions (e.g., will the Las Vegas Raiders win the Superbowl, will Liverpool win the Premiere League, etc.). For example, if the user is a Las Vegas Raiders fan, the user may be offered a 10% rebate if the Raiders win their division, a 25% rebate if the Raiders win their conference, and a 50% rebate if the Raiders win the Superbowl. The user can then select a particular rebate, which will become active if the prediction is deemed accurate (i.e., comes true).

In a preferred embodiment, the offered predictions are based on the user's interest, which can either be provided by the user (e.g., via a questionnaire) or ascertained by information known on the user (e.g., the city and/or state linked to their financial information, their IP address, etc.). If a questionnaire is used, the questions (or provided answers) may be very specific (e.g., my favorite sports team is the Las Vegas Raiders) or quite general. This information (along with betting lines received from an online bookmaker) is then used to offer a plurality of rebates to the user, with each rebate being tied to a particular prediction. The user is allowed to select one rebate from the plurality of rebates offered. If the prediction associated with the rebate selected by the user comes true (e.g., the Raiders win the Superbowl), the rebate will then be activated and processed, resulting in a refund to the user in an amount identified in the rebate.

From the user's standpoint, they are merely making a prediction associated with a particular rebate amount or percentage. However, in order to fund the selected rebate, the host should place a corresponding wager with an online bookmaker. To this end, the host uses the commission (or a portion thereof) received as a result of the user's purchase to make the wager. In one embodiment, the host provides the user with a plurality of rebate options, with each option being tied to a particular prediction. To do this, the host may use information available to the host, including the commission received as a result of the purchase, the portion of the commission that the host will wager, the wagers available from the online bookmaker, and information known about the user (e.g., their interests), to identify the plurality of rebate options.

For example, if (a) the user lives in Las Vegas and likes football (or specifically provides that they are a fan of the Raiders or believe that the Raiders will do well that year), (b) the user purchases an item from a merchant (via the host's website) for $1000, and (c) the host has allocated $10 from the received commission toward the user's rebate, then the host will identify betting lines with an online bookmaker (preferably involving the Raiders) that will provide at least a 10:1 return (sufficient for a 10% rebate), 25:1 return (sufficient for a 25% rebate), and 50:1 return (sufficient for a 50% rebate).

Assume, by way of example, that the Las Vegas Raiders are 10:1 to win their division, 25:1 to win their conference, and 50:1 to win the Superbowl, then the user may be provided with three rebate options, i.e., a 10% rebate if the Raiders win their division, a 25% rebate if the Raiders win their conference, and a 50% rebate if the Raiders win the Superbowl. In a preferred embodiment, the user would then select one of the offered rebates and the host would make a corresponding wager with an online bookmaker. If the user's prediction is accurate and the wager is won, then the user will be notified that their rebate has been activated and can be accepted for processing. By structuring the refund as a rebate, it is the host that is wagering via an online bookmaker (or casino), not the user or the merchant. The user is merely making a prediction which, if correct, will result in a rebate being activated for processing.

A more complete understanding of a system and method for generating a rebate for an online purchase of an item by a user, where the rebate is based on an outcome of a prediction selected by the user will be afforded to those skilled in the art, as well as a realization of additional advantages and objects thereof, by a consideration of the following detailed description of the preferred embodiment. Reference will be made to the appended sheets of drawings, which will first be described briefly.

### BRIEF DESCRIPTION OF THE DRAWINGS

FIG. 1 illustrates an exemplary environment in which the present invention may operate, in which a host device communicates with a user device, a merchant device, and an online bookmaker via a wide area network (WAN), such as the Internet;

FIGS. 2A-F provide exemplary screenshots in accordance with certain embodiments of the present invention, allowing a user to select a particular merchant from the host device and a particular item from a merchant for purchase;

FIGS. 3A-D provide exemplary screenshots in accordance with other embodiments of the present invention, allowing a user to share an interest of the user to a host and to select a corresponding rebate, where the rebate is contingent on the outcome of an event based on the shared interest;

FIG. 4 provides an exemplary screenshot from an online bookmaker showing the odds (i.e., betting lines) of certain NFL teams to win the Superbowl for the 2024-25 season;

FIGS. 5-7 provide exemplary databases for storing information that links a user to a particular purchase with a merchant, and a corresponding rebate, including information on an interest of the user and a corresponding wager made by a host;

FIGS. 8A-B illustrate a method for generating and activating rebate in response to a user making an online purchase from a merchant, where the rebate is based on a prediction made by the user;

FIG. 9 provides an exemplary screenshot in accordance with one embodiment of the present invention allowing a user to select a prediction from a plurality of predictions, where each prediction is linked to a corresponding rebate;

FIG. 10 provides an exemplary screenshot in accordance with another embodiment of the present invention, showing a plurality of merchants from which a user can select for purchasing at least one good or service; and

FIG. 11 illustrates an exemplary affiliate network, which acts as a middleman between a host (or affiliate) and a merchant.

### DETAILED DESCRIPTION OF THE PREFERRED EMBODIMENT

The present invention provides a system and method for using a network-connected host device to facilitate a transaction, wherein the transaction involves the purchase of an item from a merchant, where the user can select a rebate for a least a portion of the purchase price of the item after the item has been purchased, where the host device uses at least a portion of the commission received as a result of the purchase to wager on an event, where the event is related to a prediction made by the user, and the outcome of the prediction (or event) determines whether the rebate is activated for processing, thereby resulting in at least a partial refund to the user.

It should be appreciated that while the present invention is described in terms of a host website (ecommerce website) that advertises a plurality of merchants, where interacting with (e.g., clicking on) a particular advertisement results in the user being redirected to the merchant's website (corresponding to the advertisement), the present invention is not so limited. For example, embodiments where the user can purchase an item from a merchant on the host's website are within the spirit and scope of the present invention. A critical feature of the invention is not so much how the item is purchased, but the compensation that is provided to the host for facilitating the transaction and the use of said compensation (or a portion thereof) to offer a rebate to the user for said purchase, where said rebate is contingent upon a prediction made by the user. For example, in certain embodiments, as discussed in greater detail below, the present invention may operation in conjunction with at least one affiliate network.

It should also be appreciated that while the present invention is described in terms of a prediction and corresponding wager on a sporting event, the present invention is not so limited. For example, other traditional wagering activities (e.g., craps, blackjack, roulette, etc.) are within the spirit and scope of the present invention. So too are other events offered by online bookmakers, such as political outcomes, award ceremonies, upcoming celebrity births (e.g., weight, gender, birthdate, etc.), changes in the Dow Jones, etc. As such, the term “bookmaker” should be construed broadly to include any online entity that would allow the host to wager (or invest) for or against a particular outcome associated with a particular event.

It should further be appreciated that the wagering activity can be directly related to the user's stated interest, indirectly related to the user's stated interest, or related to information known about the user. For example, and respectively, a wager on the Las Vegas Raiders to win the upcoming Superbowl could be related to the user's interest in the Raiders winning the Superbowl, the user's interest in NFL football, or the fact that the user resides in Las Vegas. The wager could also be placed randomly. However, tying the wager to the user's interest is more likely to provide a more positive shopping experience and draw traffic to the host's website, for both new and repeat customers.

While other events can be linked to the user's rebate, sports wagering is preferred as it is easy to understand (e.g., the user's will clearly know if their rebate has been activated) and offers increased odds (e.g., odds of 40:1 that the Las Vegas Raiders will win the Superbowl, etc.) in the form of “futures.” This is important in that it allows a little bit of money (e.g., the commission on a purchase, or a portion thereof) to win a larger amount of money (e.g., 50% of the purchase price). It should be appreciated that the host can make money by either retaining a portion of the commission, retaining a portion of the winnings, advertising on their website, or any combination thereof. It should further be appreciated that while the present invention is described in terms of the purchase of an item, other purchases (e.g., services, subscriptions, etc.) are also within the spirit and scope of the present invention.

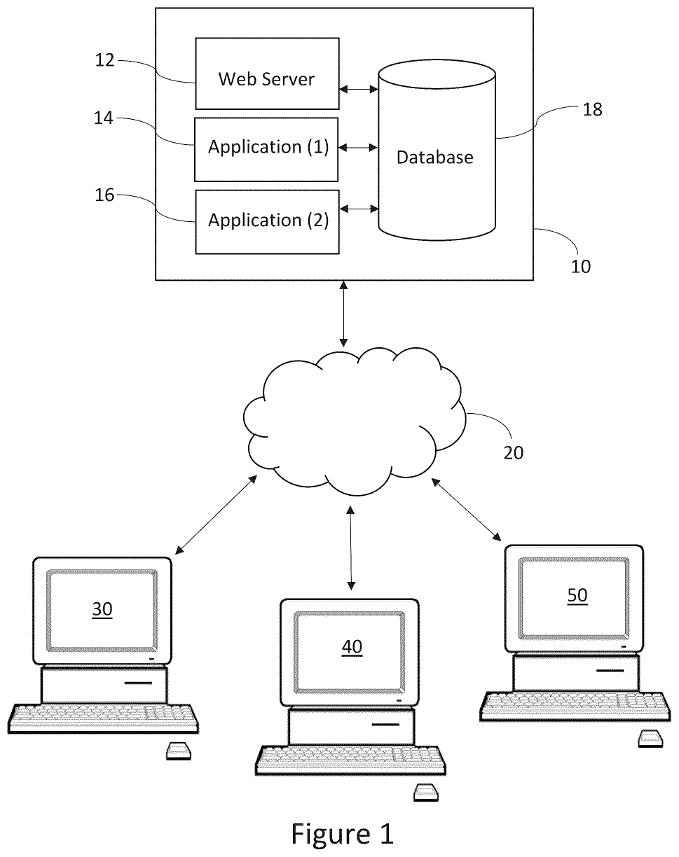

In a preferred embodiment of the present invention, as shown in FIG. 1, a host device 10 may communicate with a user device 30, a merchant device 40, and an online bookmaker 50 via a wide area network (WAN) 20, such as the Internet. The host device 10 may include a web sever 12, allowing the host device 10 to communicated with the users, merchants, and online bookmakers via the WAN 20, a database 18 for storing information (e.g., information on users, merchants, wagers, and program (or application) instructions (e.g., machine readable), etc.), a first application 14 allowing a user to purchase an item (or select a merchant from whom the item will be purchased), provide interest information, and select a rebate, and a second application 16 for identifying corresponding wagers from an online bookmaker and placing a wager corresponding to the selected rebate.

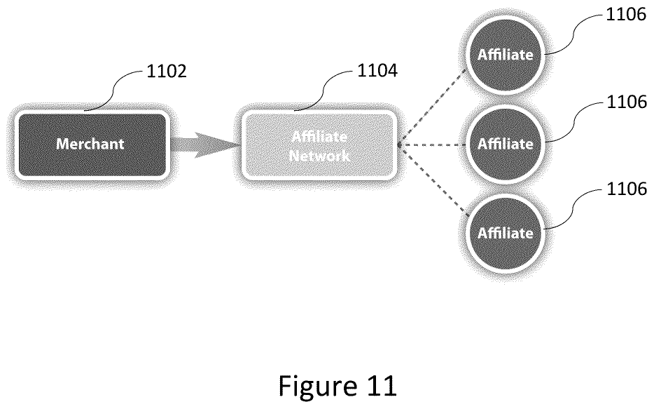

It should be appreciated that the present invention is not limited to the arrangement and/or components depicted in FIG. 1, and may include a different arrangement, different components, fewer components, or additional components. For example, as discussed below, an affiliate network may act as a middleman between the host device and the merchant device (see FIG. 11). By way of another example, both the merchant device and the online bookmaker may be in communication with other network-connected devices (e.g., the merchant device may be in communication with the user's financial institution to receive payment for a selected purchase, the online bookmaker may be in communication with the host's financial institution for placing bets and providing payouts, etc.). By way of yet another example, the host device may use one or more databases (or memory devices), located locally and/or remotely, and one or more applications (or programs), located locally and/or remotely. In other words, as long as the host can perform the functionality described herein, it does not matter whether it is performed on a single or multiple devices, by a single or multiple applications or programs, or utilize a single or multiple databases or memory devices.

In one embodiment of the present invention, the merchant (i.e., an ecommerce website offering items for sale, such as Amazon™) is responsible for offering an item for sale, where the user can purchase the item (e.g., by placing the item in a shopping cart, entering financial and shipping information, etc.). A link (or advertisement) is placed on the host's website. When the user interacts with (e.g., clicks on) the link, the user is transported to the merchant's website or application (e.g., via a hyperlink, deeplink, etc.), along with information that identifies the host and/or the user (e.g., using cookies, etc.). This may take place directly or via an affiliate network. For example, as shown in FIG. 11, clicking a link on the host's website may redirect the user from the host 1106 to the affiliate network 1104, which in turn redirects the user to the merchant 1102. This allows the affiliate network to monitor purchases made on the merchant's website that originated from the host website (e.g., for compensation, etc.) and to communicate such information (including compensation information) back to the host. In other embodiments, the user is redirected directly to the merchant's website and information concerning purchases is provided to the host either from the merchant (directly) or through a corresponding affiliate network.

If the user then purchases an item from the merchant (e.g., during the session, within a certain period of time, etc.), the merchant will pay the host a commission (e.g., either directly or via an affiliate network), which may be a flat fee and/or a portion of the purchase price. To this end, the merchant (or affiliate network) may store information that identifies the user, the host, the item(s) purchased, the purchase date/time, the purchase price, and/or the commission paid to the host. This information may then be shared with the host to identify commissions that have been or will be paid, and data surround the same (e.g., the user, item(s) purchased, purchase price, commission paid, etc.).

It should be appreciated that this information can be provided to the host from the merchant and/or the affiliate network depending on agreements or arrangements in place between the parties. For example, in one embodiment, information concerning a purchase may be provided from the merchant to the affiliate network. The same information (including information on a corresponding commission) may then be provided from the affiliate network to the host. On other embodiments, this information is provided directly from the merchant to the host. In either embodiment, this information should preferably be communicated along with a unique identifier, linking this information to a particular user and/or user session (see discussion below).

It should also be appreciated that while the preferred embodiment involves commissions that are paid based on purchases, other compensation methods are within the spirit and scope of the present invention. For example, the merchant may pay the host based on impressions (or cost per mile, also known as CPM or CPV), cost per click (or CPC), cost per acquisition or engagement (or CPE) (i.e., the preferred method), or any combination of the same. Other compensations methods generally known to those skilled in the art (e.g., revenue per mile (or RPM), cost per lead, fixed cost (e.g., cost per day (or CPD), etc.), are also within the spirit and scope of the present invention.

In the foregoing embodiment, the user may first login to the host's website, which may require the user to enter authenticating information, such as username, email address, password, biometric data, etc. The user should then provide the host with financial information, e.g., bank account, PayPal, etc., so that the user can be compensated if their rebate is activated and processed (discussed further below). If the user clicks on a link (or advertisement), then the user will be transported or redirect (directly or indirectly) to the merchant's website or application (e.g., via a hyperlink, deeplink, etc.), along with information (e.g., cookies, etc.) that identifies the host. This allows the merchant (or affiliate network) to understand that the user came to the merchant's website or application via the host's website.

Once the user is on the merchant's website, the user may be required to enter additional login (or authenticating) information. In alternate embodiments, cookies can be used to identify and authenticate the user. The user may then be able to search (or browse) the merchant's website and select an item for purchase and place the item in the user's virtual shopping cart on the merchant's website (i.e., a virtual shopping cart that is linked to the user's session with the merchant). The user may then provide the merchant with payment information, e.g., a credit card, etc., to pay the purchase price. In an alternate embodiment, payment information may be previously provided by the user and linked to the user's account with the merchant. The item can then be shipped and commission(s) paid to the host.

At this time, the host may offer at least one rebate to the user for the item purchased from the merchant. In a preferred embodiment, the host offers a plurality of rebates to the user, where each rebate offers a different percentage of the paid purchase price (e.g., the price of the item prior to tax, shipping, etc.). For example, the user may be offered a 10% rebate, a 25% rebate, and a 50% rebate. It should be appreciated that other percentages or rebate amounts are within the spirit and scope of the present invention, up to and including 100% of the purchase price.

Unlike a traditional rebate, however, the rebates in the preferred embodiment are tied to a prediction made by the user (e.g., will the Las Vegas Raiders win the Superbowl, will Liverpool win the Premiere League, etc.). For example, if the user is a Las Vegas Raiders fan, the user may be offered a 10% rebate if the Raiders win their division, a 25% rebate if the Raiders win the conference, and a 50% rebate if the Raiders win the Superbowl. The user can then select a particular rebate, which will become active if the prediction is deemed accurate (i.e., comes true).

In a preferred embodiment, the user is provided with events that are of interest to the user, where the user's interests can either be provided by the user (e.g., via a questionnaire) or ascertained by information known on the user (e.g., the city and/or state linked to their financial information, their IP address, etc.). However, providing the user with events that are of general interest (e.g., major televised events, etc.) is also within the spirit and scope of the present invention (e.g., when little is known on the user, when the user's interests do not match events provided by the online bookmaker, when the user's interests will not provide the needed return, etc.).

If a questionnaire is used, the questions (or provided answers) may be very specific (e.g., my favorite sports team is the Las Vegas Raiders) or quite general. If general, the questions may also be tiered. For example, a user may first select one or more sports of interest (e.g., football, baseball). Depending on their answer, the user may then be given a chance to select one or more teams (e.g., Rams, Dodgers), players (e.g., Stafford, Ohtani), or events (e.g., Superbowl, World Series) of interest. It should be appreciated that these questions could be asked early in the process (e.g., during registration) or later (e.g., after a purchase has been made). The user's interest and betting lines provided by the online bookmaker are used by the host to identify and offer to the user a plurality of rebates.

In a preferred embodiment, the user is allowed to select one rebate from a plurality of rebates, with each rebate being tied to a particular prediction. However, in other embodiments, the user may be allowed to select more than one rebate. If the prediction associated with the rebate selected by the user comes true (e.g., the Raiders win the Superbowl), the rebate will then be activated, and the user can then accept or submit the rebate to be processed. In a preferred embodiment, the user's financial information with the host will be used to process the refund (e.g., 50% of the purchase price). In other embodiments, however, other financial information (e.g., the credit card used for the purchase) may be used, or the user could be provided with a credit (e.g., on the host's website, on the merchant's website, etc.) for future purchases.

From the user's standpoint, they are merely making a prediction associated with a particular rebate amount or percentage-they are not gambling nor aware of bets that are being made by the host to compensate for the rebate. In other words, it is the host (and perhaps only the host) that is aware of the commission that was received as a result of the purchase, the portion of the commission that will be used to ensure (or fund) the selected rebate, and the wagers available from the online bookmaker. The host would then use this information, along with information known about the user (e.g., their interests) to provide the user with a plurality of rebate options. For example, if (a) the user lives in Las Vegas and likes football (or specifically provides that they are a fan of the Raiders or believe that the Raiders will do well that year), (b) the user purchases an item from a merchant (via the host's website) for $1000, and (c) the host has allocated $10 from the received commission toward the user's rebate, then the host will identify betting lines with an online bookmaker (preferably involving the Raiders) that will provide at least a 10:1 return (sufficient for a 10% rebate), 25:1 return (sufficient for a 25% rebate), and 50:1 return (sufficient for a 50% rebate).

Assume, by way of example, that the Las Vegas Raiders are 10:1 to win their division, 25:1 to win their conference, and 50:1 to win the Superbowl, then the user may be provided with three rebate options, i.e., a 10% rebate if the Raiders win their division, a 25% rebate if the Raiders win their conference, and a 50% rebate if the Raiders win the Superbowl. In a preferred embodiment, the user would then select one and the host would make a corresponding bet with the online bookmaker, which should remain unbeknown to the user, as the user is merely making a prediction, not placing a bet or wager. If the user's prediction comes true, then the user will be notified (e.g., via email or text) that their rebate has been activated and can be accepted for processing.

Clearly, the foregoing is merely an example, and other examples or embodiments are within the spirit and scope of the present invention. For example, the user may be provided with different, additional, or fewer rebate options, may be allowed to select more than one rebate, may be provided with rebates that are unrelated to the user's interest, and/or may be provided with a rebate that is unrelated to a specific prediction (e.g., a $10 rebate that is not contingent on any prediction), to name a few. By way of another example, the winnings from the bookmaker may exceed the amount needed to provide the user with the selected rebate and may therefore be awarded to the host. For example, if the odds of the Raiders winning the Superbowl are 52:1, and only 50:1 odds are needed for a 50% rebate, then the host would also profit as a result of the user's accurate prediction (e.g., 2:1 on the wager). Alternatively, the host may wager a lesser amount (e.g., $9.62) to ensure sufficient funds. The host may even wager less to account for the fact that the host will receive both the wager amount and the winnings from the bookmaker if the wager is won.

Thus, given the amount to wager (e.g., a percentage of the commission), the host will need to identify wagers that (a) match at least one of the user's interest and (b) will provide at least the necessary return (e.g., 10% rebate, 25% rebate, etc.), and determine an actual amount of money that will need to be wagered to receive the desired return on the selected rebate, given the specific odds at the time the wager is being made. As such, the host (or the program (application) operating thereon) should be able to communicate with the online bookmaker (e.g., casino) and receive various wagering events (including their odds) to determine events that would provide sufficient returns. It should be appreciated that a “wagering event” can be an individual event (e.g., who wins the World Series) or multiple events, commonly referred to as a “parlay” (e.g., who wins the World Series and the Superbowl, with a requirement that both events must come true in order for the host to win). Thus, the host should be configured to take into account the promised payout, the commission (or wagering portion thereof), the odds, and the user's interests in making the wagering event.

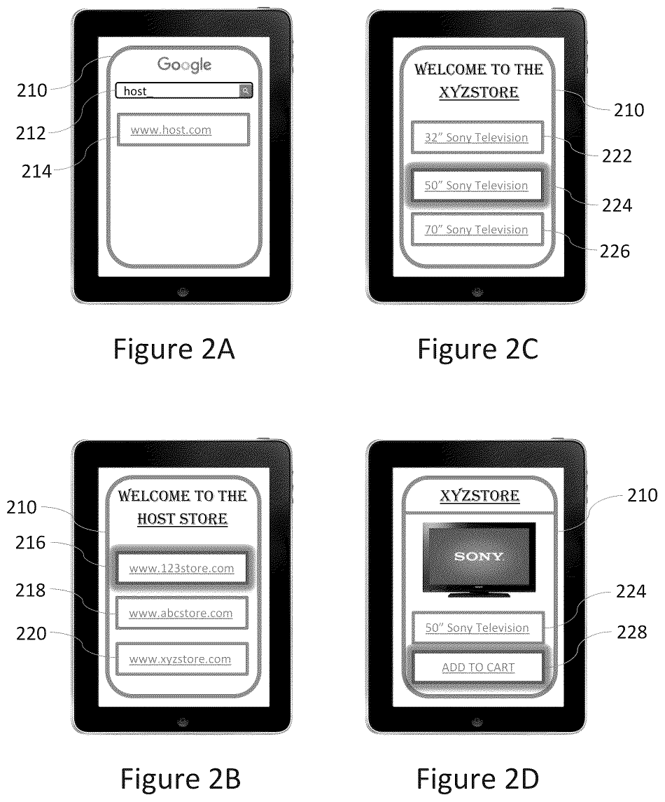

Exemplary screen shots of a preferred embodiment can be seen in FIGS. 2A-F. As shown in FIG. 2A, the user can “point” a web browser 210 to the host's website (e.g., by entering the host's name in the search field 212 of Google™ and clicking on the host's website 214 in the search results). As shown in FIG. 2B, the user may then be able to select from a plurality of merchants. For example, the user may select from merchants advertising on the host's website, e.g., www.123store.com 216, www.abcstore.com 218, or www.xyzstore.com 220. Once a merchant has been selected, the user is then transported or redirected (directly or indirectly) to the merchant's website (or application), along with information identifying the user and the host (e.g., cookies). The user may then be able to select from a plurality of items. For example, as shown in FIG. 2C, if the user is interested in purchasing a TV, then the user may be able to select from a 32-inch Sony™ television 222, a 50-inch Sony™ television 224, and a 70-inch Sony™ television 226. If the user selects the 50-inch Sony™ television (e.g., by clicking on the hyperlink associated with the “50” Sony Television”), the user may be presented with information on the selection, including an image of the selection and information on the selection (see FIG. 2D). The user may then have the option of adding the selection to their virtual shopping cart (i.e., a virtual shopping cart associated with the user's session with the xyzstore) (e.g., by clicking on “Add to Cart” 228).

As shown in FIG. 2E, the user may then be provided with the content of their virtual shopping cart 230, which in this example is the 50-inch Sony™ television, with an option to purchase the television by clicking on the “Purchase” button 232. As shown in FIG. 2F, the user would then enter payment information, which may include the user's name 236, address 238, and a payment method 240 (e.g., Citibank, Mastercard, Visa, PayPal, Zelle, etc.). Other information may also be required, such as shipping information (not shown). Alternatively, if the user logged into the xyzstore website upon arrival (or they were otherwise identified, e.g., via cookies), payment and/or shipping information linked to the user's account (as previously provided) may be used to facilitate the transaction. Information concerning the purchase (e.g., user, purchase price, commission due, etc.) would then be communicated to the host (e.g., directly or via an affiliate network) and stored in a database (discussed in greater detail below).

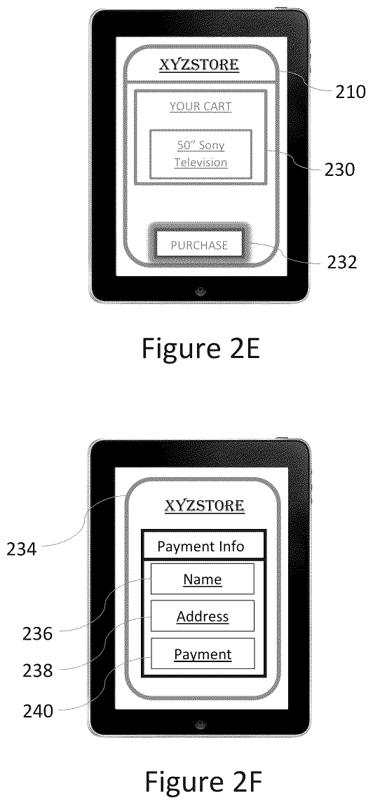

The user may also (either before or after the purchase) be allowed to provide information (e.g., interest) in order to receive rebates on items purchased. To do this, the user would navigate to the host's website (see, e.g., FIG. 2A) and login (e.g., enter name, email address, password, etc.). At some point in time the user would also enter financial information (e.g., bank account, PayPal, etc.) so that the user can be compensated if the rebate is activated (i.e., their prediction is accurate). Once logged in, as shown in FIG. 3A, the user may be allowed to select a sport of choice, e.g., Football 310, Baseball 312, or Soccer 314. If the user selects Football 310, he may then be provided with a series of wagering events, such as who will win the Superbowl. See FIG. 3B. This could also be couched as “please select your favorite team” as opposed to making a specific prediction. The host could then make a corresponding wager with the online casino.

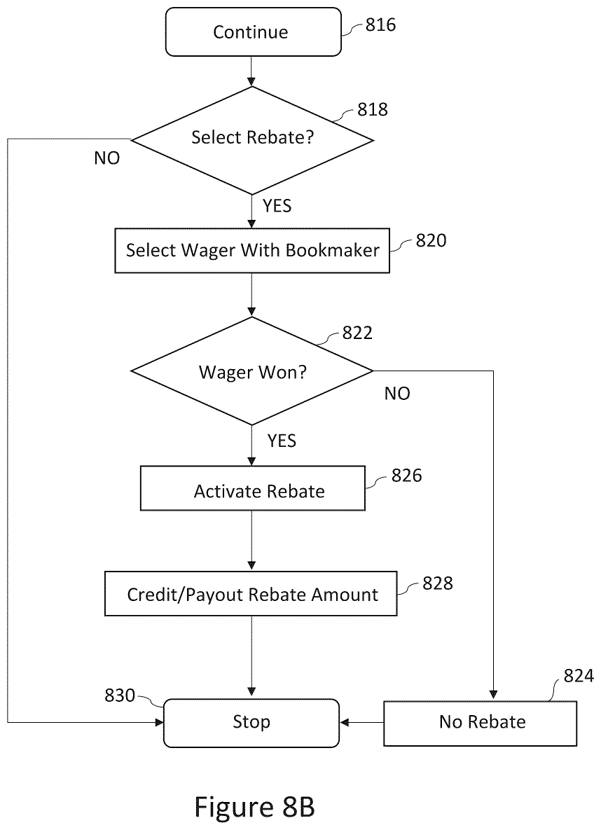

Obviously, these selections are merely exemplary, and other items of interest and events (see, e.g., FIG. 9) are within the spirit and scope of the present invention. If the host's wager wins (i.e., the user's prediction is correct), then the user may be notified (e.g., via the host's website, email, text message, etc.) that their prediction was correct as shown in FIG. 3C. The rebate can then be accepted or submitted for processing. If the host's wager is lost (i.e., the user's prediction is incorrect), then the user may be notified (e.g., again, via the host's website, email, text message, etc.) as shown in FIG. 3D. In certain embodiments, if the user's prediction is incorrect, the user may be presented with other options, e.g., to select another rebate (resulting in another wager), to make another purchase to be eligible for another rebate, etc.

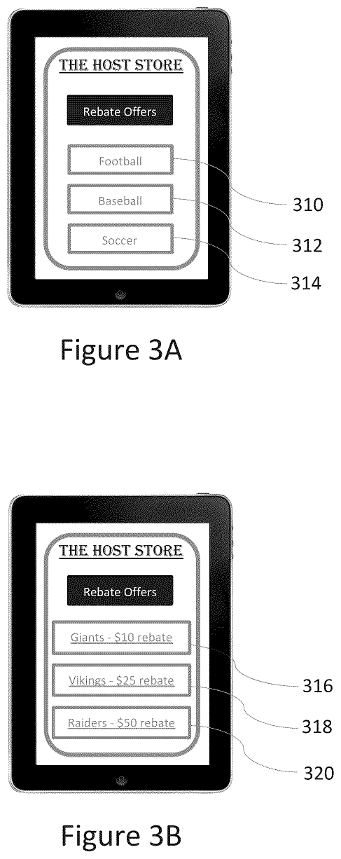

In order to acquire wagering events and betting lines, the host 10 may communicate with an online bookmaker 50. See FIG. 1. For example, as shown in FIG. 4, assuming the user is interested in NFL football, the bookmaker 50 may provide the host 10 with information on odds associated with this event. The host 10 may then analyze this information to identify wagers that would meet the given criteria. For example, if odds of at least 20:1 are necessary to provide the user with a 20% rebate (based on the amount being wagered and the purchase price), then the host 10 can use the acquired information to identify acceptable wagers (e.g., Dolphins, Steelers). The host 10 could then either provide corresponding predictions to the user (e.g., allowing the user to choose one from a plurality of 20% rebates) and/or provide additional predictions from which the user could choose from (e.g., a 10% rebate if the Giants with the Superbowl, a 50% rebate if the Raiders win the Superbowl, a 100% rebate if the Patriots win the Superbowl, etc.).

Clearly, FIG. 4 is exemplary and other wagering events and betting lines are within the spirit and scope of the present invention. The user may also be allowed to select a wagering event that does not meet (or exceeds) the given criteria, understanding that the payouts of such an event may vary. For example, if the user selects the Chiefs to win the Superbowl, the rebate may be less (e.g., $10, or $20 if the $10 wager amount is added to the $10 winnings). Similarly, if the user selects the Packers to win the Superbowl, the compensation may be more (e.g., $40, or $50 if the $10 wager amount is added to the $40 winnings). It should also be appreciated that betting lines will often result in a payout that is either slightly more or slightly less than the rebate offered. If more, any extra winnings can either be kept by the host or passed on to the user. If less, the host may use a portion of the remaining commission (the portion not wagered) to ensure sufficient funds for the rebate offered.

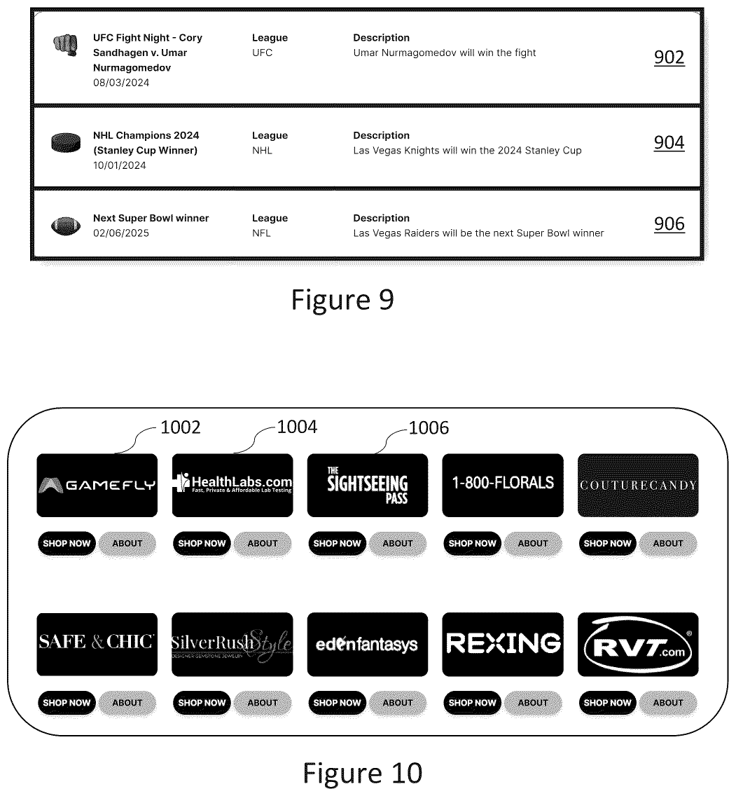

Additional features of the present invention will now be provided. As shown in FIG. 10, a website and/or application may serve as a “directory” showing advertising for those entities that have affiliate agreements with the host, making the host an affiliate marketer. A user that goes to the host's website may select (click on) one of the advertisements (1002, 1004, 1006), resulting in the user being transported or redirected to the corresponding merchant's website or application, where the user can then shop (e.g., select and purchase merchandise). In certain embodiments, the user may first be directed to the affiliate network and then redirected to the merchant's website or application. Information concerning sales made to users that originated from the host's website, corresponding commissions, etc., are then reported (e.g., from the merchant and/or affiliate network) back to the host. At the time of receiving (or being notified about) a sale and/or commission (or shortly thereafter), the host will then use at least part of the commission to enter a bet on a wagering event based on a prediction made by the user. Preferably the user will select the prediction from a plurality of predictions offered by the host, where each prediction corresponds to a particular rebate amount or percentage. If the prediction is correct (e.g., the host bet is won), the corresponding rebate will be activated and processed (e.g., automatically or after it has been accepted or submitted by the user), resulting in a refund to the user of the rebate amount.

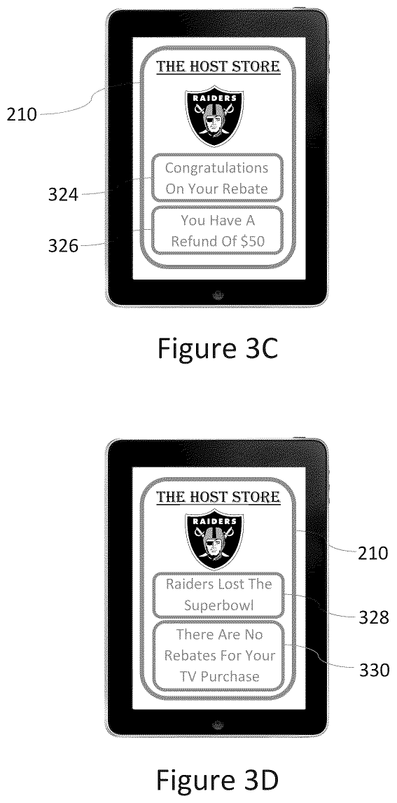

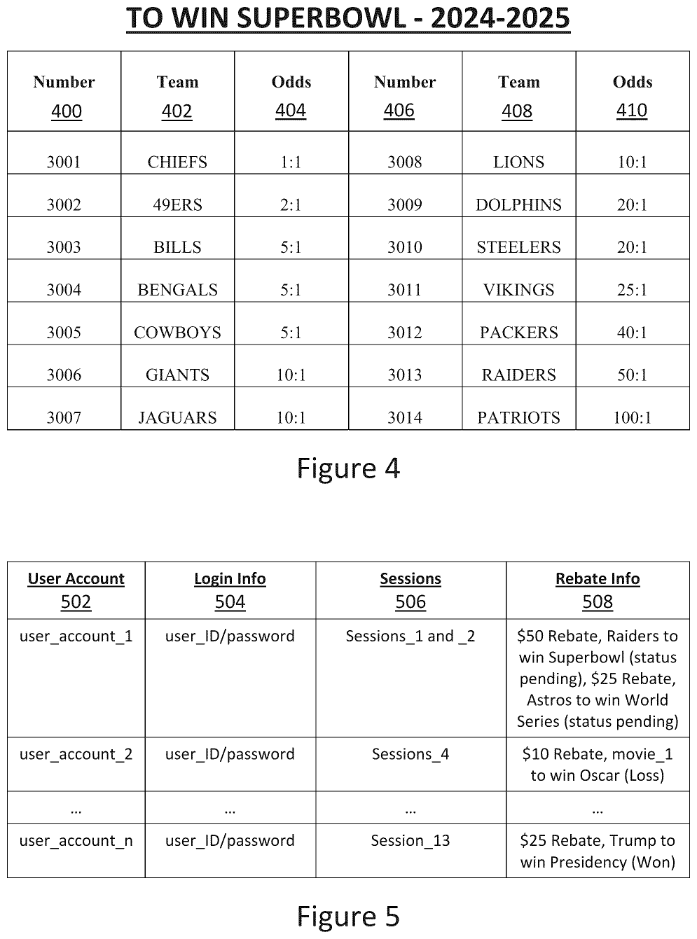

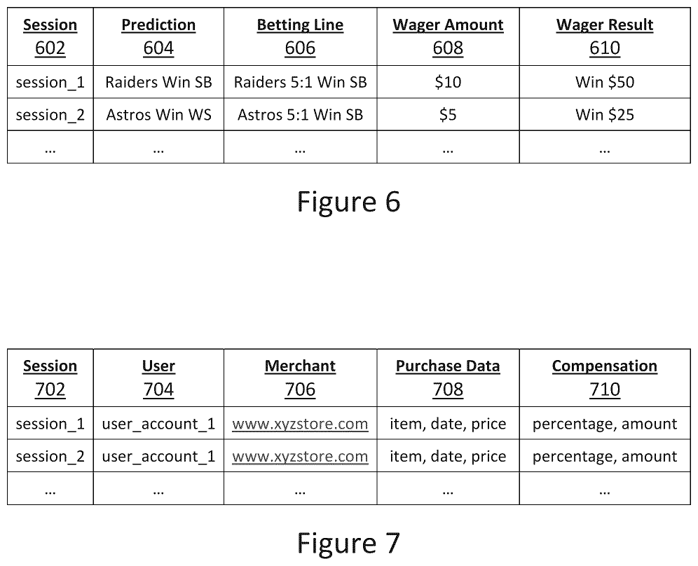

It should be appreciated that when the user makes a purchase, information concerning the purchase and the commission will be reported to the host (e.g., from the merchant and/or the affiliate network). Preferably this information will be stored in a database by the host. For example, as shown in FIG. 5, information on the user (e.g., account 502, password 504) may be linked to a particular selection of a merchant, or “session” 506, which in turn may be linked to a particular merchant 706, purchase data 708, and compensation 710 (see FIG. 7). The database may further be updated to identify a selected rebate or prediction (see FIG. 5 at 508) and a corresponding wager (see FIG. 6 at 604, 606, 608, and 610). The database may also show the status of the wager (e.g., if the wager has been won or lost) (see FIG. 6) and rebate (e.g., if the rebate has been activated, accepted, and/or processed) (see FIG. 5). Obviously, other information concerning the user's purchase, rebates offered, rebate selected, betting lines, wagers made, etc., including the storage thereof, are within the spirit and scope of the present invention.

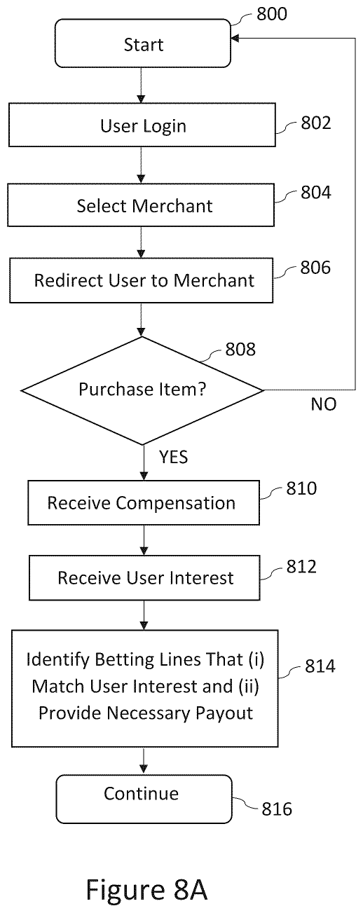

A method in accordance with one embodiment of the present invention is provided in FIGS. 8A and B, starting at step 800, with the user logging into the host's website at step 802. The user would then have the option of selecting a merchant from a plurality of merchants at step 804, resulting in the user being redirected (directly or indirectly) to the merchant's website or application at step 806. If the user purchases an item from the merchant at step 808, information concerning the purchase (e.g., item, purchase amount, commission paid, etc.) is then communicated to the host at step 810. Depending on the embodiment, this communication would either come from the merchant or the affiliate network. The user would then have an opportunity to provide the host with interest information at step 812 (e.g., a particular sport, a particular team, a particular event, etc.). At step 814, the host would then identify betting lines that correspond to the user's interest and different rebate options (e.g., to provide a 10% rebate, a 25% rebate, and a 50% rebate).

The user can then select a particular rebate at step 818, resulting in the host making a corresponding wager with the bookmaker at step 820. If the wager is won at step 822, then the user is notified that the rebate has been activated at step 826 and a refund is provided to the user at step 828 (e.g., automatically, after the rebate has been accepted by the user, etc.). If the wager is lost at step 822, then the user is notified that the rebate is not available or has been deactivated at step 824.

It should be appreciated that the present invention is not limited to the steps shown in FIGS. 8A and B and methods or processes involving different, additional, or fewer steps are within the spirit and scope of the present invention. For example, the user may provide interest information to the host (or the host may acquire interest information) prior to the purchase being made. The host may also require the user to perform additional steps before processing the rebate (e.g., the user may have to accept or submit the rebate for processing). In one embodiment, if the wager is lost, the user may be provided with additional options (e.g., to make another purchase from the merchant or from another merchant, to select another (e.g., smaller) rebate (which would require the host to place another wager), etc. In another embodiment, if the user does not participate in the rebate selection process, the system may either provide no rebate (make no wager) or select a default rebate for the user.

A critical feature of the present invention is that the user is not gambling but merely making a prediction that, if accurate, will result in a rebate. It is the host that is making wagers or gambling—not the user, the merchant, or the affiliate network. The user is merely requesting a rebate based on a prediction. In selecting events to be offered, the host may determine an arbitrary minimum level of net commission that the host will make for all transactions. Thus, for example, if an affiliate pays a 25% commission on the purchase price, and the amount of the sale is $100.00, then the gross commission paid to host would be $25.00. If the host determines 10% to be the target net commission ($10.00), then the host should consider bets of $15.00 that if won would result in certain rebates (e.g., 10% rebate, 25% rebate, etc.).

The foregoing description of a system and method for generating a rebate for an online purchase of an item by a user, where the rebate is based on an outcome of a prediction selected by the user, has been presented for the purposes of illustration and description. It is not intended to be exhaustive or to limit the invention to the precise forms disclosed, and many modifications and variations are possible in light of the above teachings. For example, other information may be communicated from the merchant to the host (either directly or via the affiliate network), such as the item subsequently being returned, which may void the rebate offered to the user. Those skilled in the art will appreciate that there are a number of ways to implement the foregoing features, and that the present invention it not limited to any particular way of implementing these features. The invention is solely defined by the following claims.

What is claimed is:

1. A method for generating a rebate for an online purchase of at least one item by a user, said generation of said rebate being based at least in part on an outcome of a prediction selected by said user, comprising:
receiving by a host device operated by a host and having a host website login data from a user device operated by said user, said user subsequently using at least said host website to select and purchase said at least one item from a merchant;
receiving by said host device compensation data identifying compensation paid to said host in response to said user purchasing said at least one item from said merchant;
receiving by said host device said prediction from said user, said host device linking said prediction to a corresponding betting line available from an online bookmaker;
placing by said host device a wager with said online bookmaker via said WAN, said wager being on said corresponding betting line and for an amount that is equal to or less than said compensation paid by said merchant to said host in response to said user purchasing said at least one item from said merchant;
receiving by said host device a result of said wager from said online bookmaker, said host device comparing said result of said wager with said predictive outcome to determine whether that is a match therebetween;
providing by said host device said rebate to said user when said result of said wager matches said prediction, acceptance of said rebate by said user resulting in at least a portion of a price of said purchase to be returned to said user from said host device; and
providing by said host device an electronic message to said user when said result of said wager differs from said prediction, said electronic message indicating that said rebate is not available for said purchase.

2. The method of claim 1, wherein said step of using at least said host website to select and purchase said at least one item from a merchant further comprising using said host website to select said merchant from a plurality of merchants offered on said host website, said selection of said merchant resulting in said user device being redirected directly or indirectly to a merchant website where said at least one item can be selected and purchased by said user.

3. The method of claim 2, wherein said compensation data is received from an affiliate network and further identifies said user, said price of said purchase, and a date of said purchase, said affiliate network acting as a middleman between said host and said merchant for notifying said host as to purchases made on said merchant's website and compensation due as a result thereof.

4. The method of claim 1, wherein said step of receiving by said host device said prediction from said user further comprises providing said user with a plurality of predictions and allowing said user to select said prediction from said plurality of predictions.

5. The method of claim 4, further comprising receiving by said host device at least one interest from said user of a particular sports team, sporting event, or element associated therewith, including a particular sport, a geographical location, or a sports player, wherein said at least one interest is used by said host device to select said plurality of predictions from a plurality of betting lines offered by said online bookmaker.

6. The method of claim 4, wherein a first one of said plurality of predictions is linked to a first rebate for a first percentage of said price of said purchase and a second one of said plurality of predictions is linked to a second rebate for a second percentage of said price of said purchase, said first percentage being different and distinct from said second percentage.

7. The method of claim 4, wherein a first one of said plurality of predictions is linked to a first rebate for a portion of said price of said purchase and a second one of said plurality of predictions is linked to a second rebate for said price of said purchase.

8. The method of claim 6, wherein said first and second ones of said plurality of predictions are selected based on betting lines that, if said amount is wagered, would return at least said first and second percentages of said price of said purchase, respectively.

9. The method of claim 8, wherein said first and second ones of said plurality of predictions are further selected based on at least one interest of said user as provided to said host device of a particular sport, sports team, sporting event, sports player, or geographical location, including a city, state, or country.

10. The method of claim 6, wherein said first and second ones of said plurality of predictions are selected based on betting lines that, if said amount is wagered, would return at least said first and second percentages of said price of said purchase, respectively.

11. A system for generating a rebate for an online purchase of at least one item by a user, said generation of said rebate being based at least in part on an outcome of a prediction selected by said user, comprising:
a host in communication with a user, an affiliate network, and a bookmaker via a wide area network (WAN), said host comprising at least one memory device for storing machine readable instructions adapted to perform the steps of:
receiving by said host login data from said user, said logged in user being allowed to interact with at least a host website to select and purchase said at least one item from a merchant affiliated with said affiliate network;
receiving by said host compensation data from said affiliate network via said WAN, said compensation data identifying compensation paid in response to said user purchasing said at least one item from said merchant;
receiving by said host said prediction from said user, said host linking said prediction to a corresponding betting line available from said bookmaker;
placing by said host a wager with said bookmaker via said WAN, said wager being on said corresponding betting line and for an amount that is equal to or less than said compensation paid by said merchant to said host in response to said user purchasing said at least one item from said merchant;
receiving by said host a result of said wager from said bookmaker, said host comparing said result of said wager with said predictive outcome to determine whether that is a match therebetween;
providing by said host said rebate to said user when said result of said wager matches said prediction, acceptance of said rebate by said user resulting in at least a portion of a price of said purchase to be returned to said user from said host; and
providing by said host an electronic message to said user when said result of said wager differs from said prediction, said electronic message indicating at least that said rebate is not available.

12. The system of claim 11, wherein a plurality of merchants are offered on said host website and said machine readable instructions are further adapted to allow said user to select said merchant from said plurality of merchants, said selection of said merchant resulting in said user being redirected to a merchant website either directly or via said affiliate network where said at least one item can be selected and purchased by said user.

13. The system of claim 11, wherein said compensation data further identifies said user, said price of said purchase, and a date of said purchase.

14. The system of claim 11, wherein said machine readable instructions are further configured to provide said user with a plurality of predictions on said host website and allow said user to select said prediction from said plurality of predictions.

15. The system of claim 14, wherein said machine readable instructions are further configured to receive at least one interest from said user on a particular sports team, sporting event, or element associated therewith, including a particular sport, a geographical location, or a sports player, wherein said at least one interest is used by said host to select said plurality of predictions from a plurality of betting lines offered by said bookmaker.

16. The system of claim 14, wherein said machine readable instructions are further configured to link a first one of said plurality of predictions to a first rebate for a first percentage of said price of said purchase and link a second one of said plurality of predictions to a second rebate for a second percentage of said price of said purchase, said first percentage being different and distinct from said second percentage.

17. The system of claim 14, wherein said machine readable instructions are further configured to link a first one of said plurality of predictions to a first rebate for a portion of said price of said purchase and link a second one of said plurality of predictions to a second rebate for said price of said purchase.

18. The system of claim 16, wherein said machine readable instructions are further configured to select said first and second ones of said plurality of predictions based on betting lines that, if said amount is wagered, would return at least said first and second percentages of said price of said purchase, respectively.

19. The system of claim 18, wherein said machine readable instructions are further configured to select said first and second ones of said plurality of predictions based on a user's selection of at least one sport, sports team, sporting event, sports player, or geographical location.

20. The system of claim 16, wherein said machine readable instructions are further configured to select said first and second ones of said plurality of predictions based on betting lines that, if said amount is wagered, would return at least said first and second percentages of said price of said purchase, respectively.
